(19) United States
(12) Patent Application Publication
(10) Pub. No.: US 2013/0323969 A1
(43) Pub. Date: Dec. 5, 2013

(54) SOCKET FOR ELECTRONIC COMPONENTS

(71) Applicant: ALPS ELECTRIC CO., LTD., Tokyo (JP)

(72) Inventors: Takeki Uozumi, Miyagi-Ken (JP); Nobuyuki Okuda, Miyagi-Ken (JP); Shigetomo Chiba, Miyagi-Ken (JP)

(73) Assignee: ALPS ELECTRIC CO., LTD., Tokyo (JP)

(21) Appl. No.: 13/891,537

(22) Filed: May 10, 2013

(30) Foreign Application Priority Data
Jun. 1, 2012 (JP) 2012-125683

(51) Int. Cl. H01R 13/659; H01R 43/00

(52) U.S. Cl. CPC H01R 13/659; H01R 43/00
USPC 439/607.01; 29/884

(57) ABSTRACT

A socket for electronic components includes a shield plate assembly that is formed by combining first shield plates with second shield plates in the form of a lattice and has conductivity, and contact units electrically connected to electrode terminals of electronic components are disposed in openings of the lattice of the shield plate assembly so that the electrode terminals are electrically connected to the wiring of a wiring board. The shield plate assembly is formed in a shape where lines where openings of the lattice are lined up in a first direction are arranged side by side in a second direction orthogonal to the first direction, and the openings of the adjacent lines are formed so as to be shifted relative to the openings of the next lines in the first direction by a half of the length of the side of the opening that extends in the first direction.

### CLAIM OF PRIORITY

This application claims benefit of priority of Japanese Patent Application No. 2012-125683 filed on Jun. 1, 2012, which is hereby incorporated by reference in its entirety.

### FIELD OF THE DISCLOSURE

The present disclosure relates to a socket for electronic components, and more particularly, to a socket for electronic components capable of coping with electronic components where electrode terminals are arranged at intersections of a rhombic lattice and being manufactured at a lower cost.

### DESCRIPTION OF THE RELATED ART

In recent years, particularly, MPUs (Micro Processing Unit) where electrode terminals are arranged at the positions of intersections of a rhombic lattice have been developed for easy wiring in the MPU. Accordingly, there is a demand for sockets for electronic components that copes with the MPU having this terminal arrangement. Sockets for electronic components disclosed in Japanese Unexamined Patent Application Publication No. 2010-237133 and U.S. Pat. No. 6,877,223 are known as the above mentioned sockets for electronic components.

The sockets for electronic components disclosed in Japanese Unexamined Patent Application Publication No. 2010-237133 and U.S. Pat. No. 6,877,223 will be described below with reference to FIGS. 12 and 13. FIG. 12 is a view showing the structure of a socket SO1 for electronic components disclosed in Japanese Unexamined Patent Application Publication No. 2010-237133. FIG. 13 is a view showing the structure of a socket SO2 for electronic components disclosed in U.S. Pat. No. 6,877,223.

The socket SO1 for electronic components disclosed in Japanese Unexamined Patent Application Publication No. 2010-237133 is formed by forming through holes HO in a metal block BL and embedding contact probes CP into the through holes HO as shown in FIG. 12. Since the through holes HO are formed at the positions corresponding to the arrangement of electrode terminals of an electronic component, the socket can also cope with the electronic components where electrode terminals are arranged at the intersections of a rhombic lattice.

The socket SO2 for electronic components disclosed in U.S. Pat. No. 6,877,223 has a structure where electrode terminals TR are provided at the intersections of a rhombic lattice and the periphery of the respective electrode terminals TR is covered with a shield plate assembly ST where shield plates SB formed of metal plates are combined with each other in the form of a rhombic lattice as shown in FIG. 13.

The socket SO1 for electronic components disclosed in Japanese Unexamined Patent Application Publication No. 2010-237133 and the socket SO2 for electronic components disclosed in U.S. Pat. No. 6,877,223 can cope with electronic components where electrode terminals are arranged at the intersections of a rhombic lattice. However, as for the socket SO1 for electronic components, holes need to be formed so as to correspond to the number of the contact probes CP to be embedded into the metal block BL and the contact probes CP need to be inserted into the respective through holes HO one by one. For this reason, assembly costs are apt to increase. Further, since the contact probe CP itself is also expensive, it is difficult to cope with the reduction in cost. Furthermore, as for the socket SO2 for electronic components, the shield plate assembly ST is formed by combining the shield plates SB in the form of a rhombic lattice. However, when electrode terminals TR are to be disposed in rectangular regions as shown in FIG. 13, various kinds of shield plates SB having different lengths are needed. Since thirteen kinds of shield plates SB, which include shield plates from the shortest shield plate SB1 to the longest shield plate SB13, are needed in, for example, the socket SO2 for electronic components shown in FIG. 13, the costs of components are apt to increase. For this reason, it is difficult to obtain a reduction in costs.

### SUMMARY

A socket for electronic components includes a shield plate assembly that is formed by combining a plurality of first shield plates with a plurality of second shield plates in the form of a lattice and has conductivity. Contact units, which are electrically connected to electrode terminals of electronic components, are disposed in openings of the lattice of the shield plate assembly so that the electrode terminals of the electronic components are electrically connected to the wiring of a wiring board. The shield plate assembly is formed in a shape where a plurality of lines where quadrilateral openings of the lattice are lined up in a first direction are arranged side by side in a second direction orthogonal to the first direction, and the openings of the adjacent lines are formed so as to be shifted relative to the openings of the next lines in the first direction by a half of the length of the side of the opening that extends in the first direction.

### BRIEF DESCRIPTION OF THE DRAWINGS

FIGS. 1A and 1B are views showing a socket 100 for electronic components;

FIG. 2 is a plan view of the socket 100 for electronic components that is seen from a Z1 direction of FIG. 1A;

FIGS. 3A and 3B are views showing a case 2;

FIGS. 4A and 4B are views showing a first shield plate 1a;

FIG. 5 is a perspective view showing the appearance of a second shield plate 1b;

FIG. 6 is a perspective view showing the structure of a contact unit 10;

FIGS. 7A and 7B are views showing a contact bar 20;

FIGS. 8A and 8B are views showing a state where the contact bars 20 are disposed;

FIGS. 9A and 9B are side views showing a state where spring portions 1e are engaged with engaging portions 1g;

FIGS. 10A and 10B are side views illustrating the operation of the socket 100 for electronic components;

FIG. 11 is a view illustrating a flow of steps of a method of manufacturing the socket 100 for electronic components;

FIG. 12 is a view showing the structure of a socket SO1 for electronic components disclosed in Japanese Unexamined Patent Application Publication No. 2010-237133; and

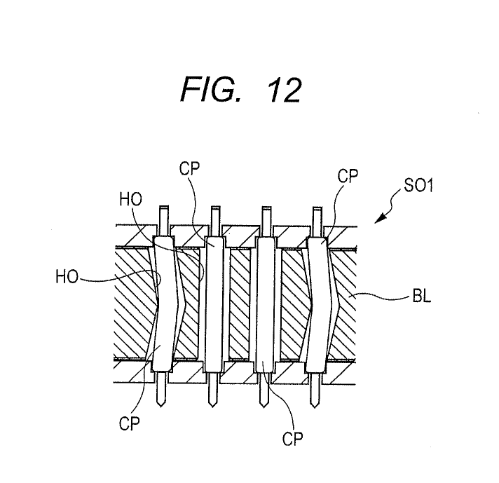

FIG. 13 is a view showing the structure of a socket SO2 for electronic components disclosed in U.S. Pat. No. 6,877,223.

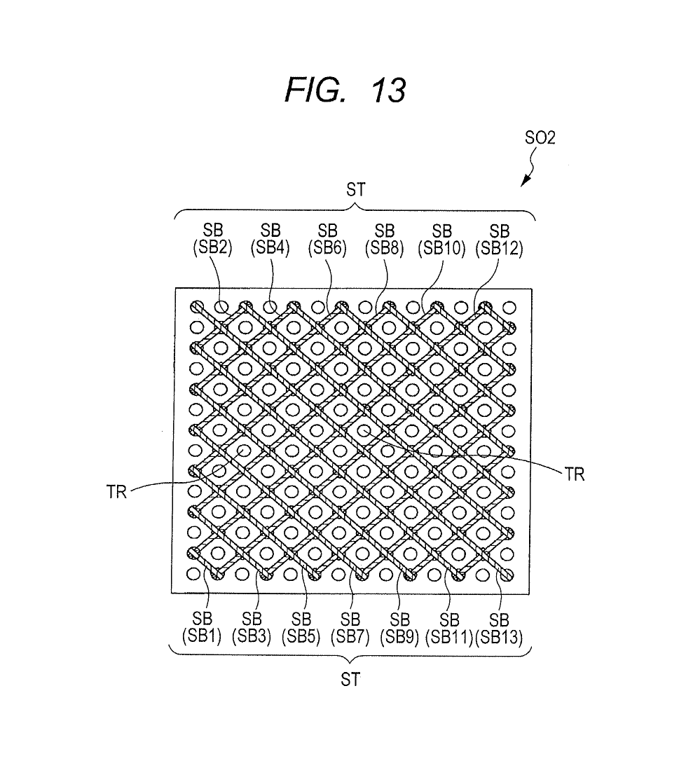

### DESCRIPTION OF THE EXEMPLARY EMBODIMENTS

### First Embodiment

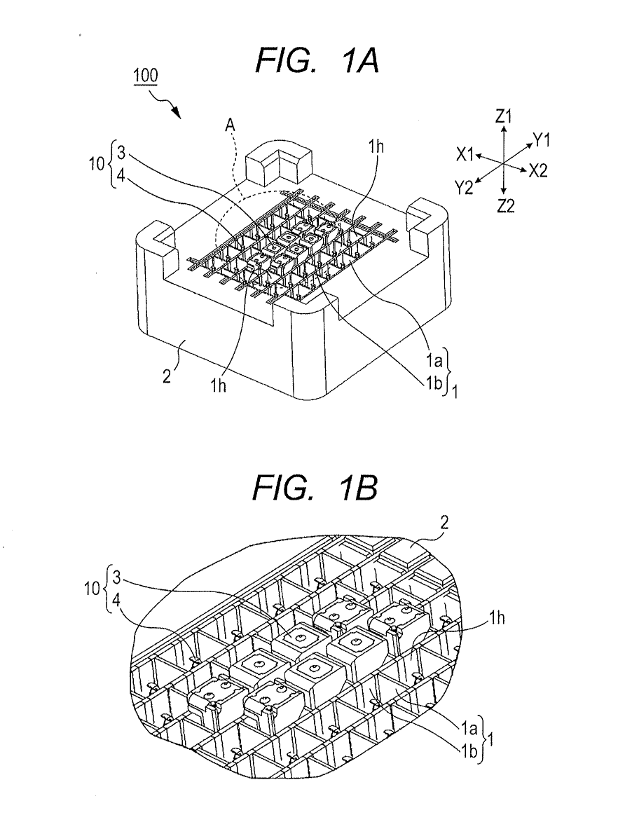

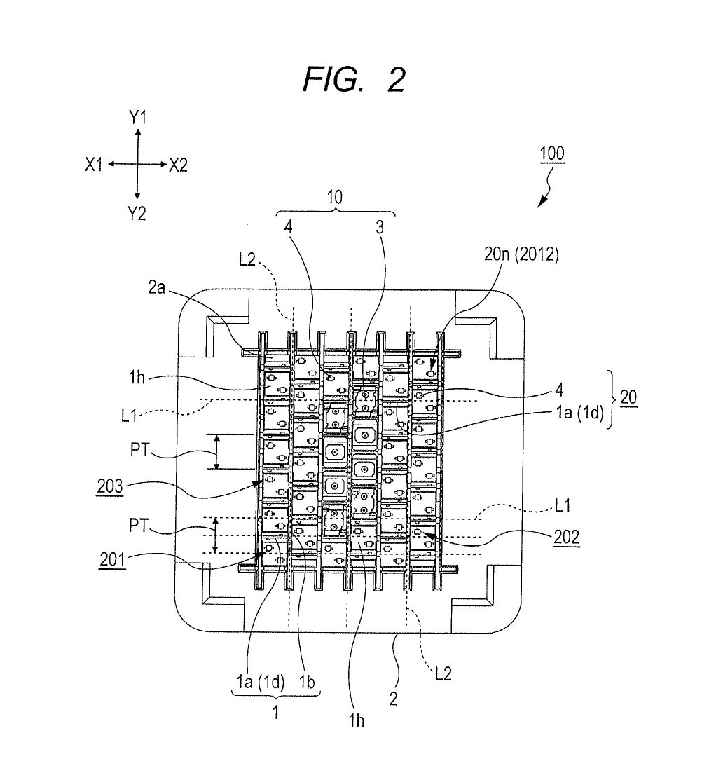

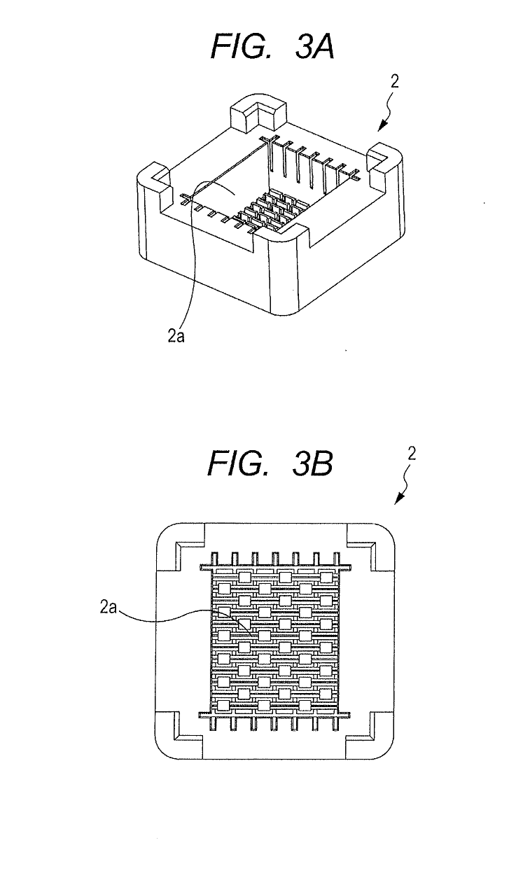

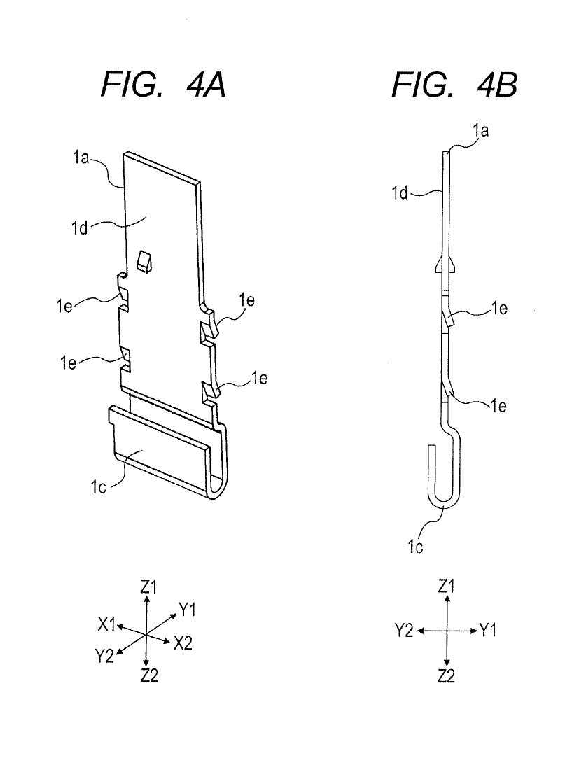

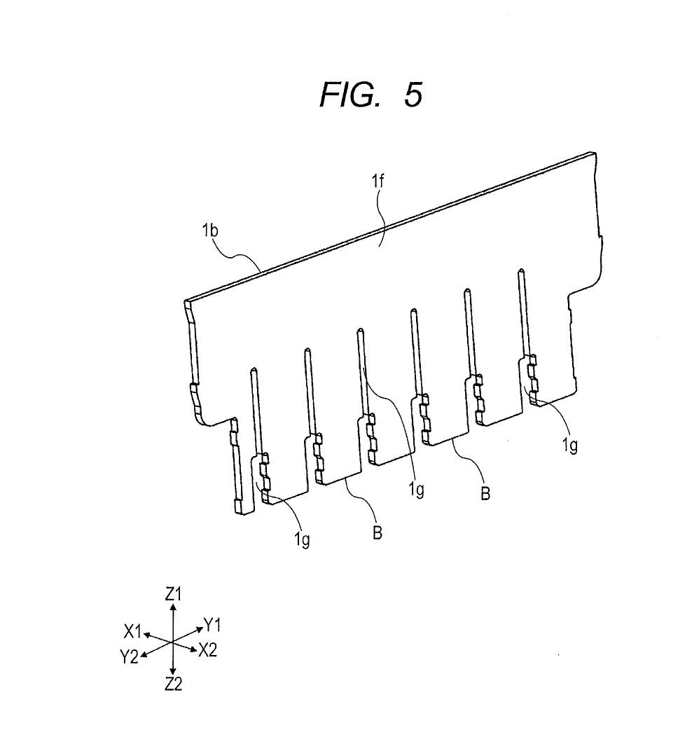

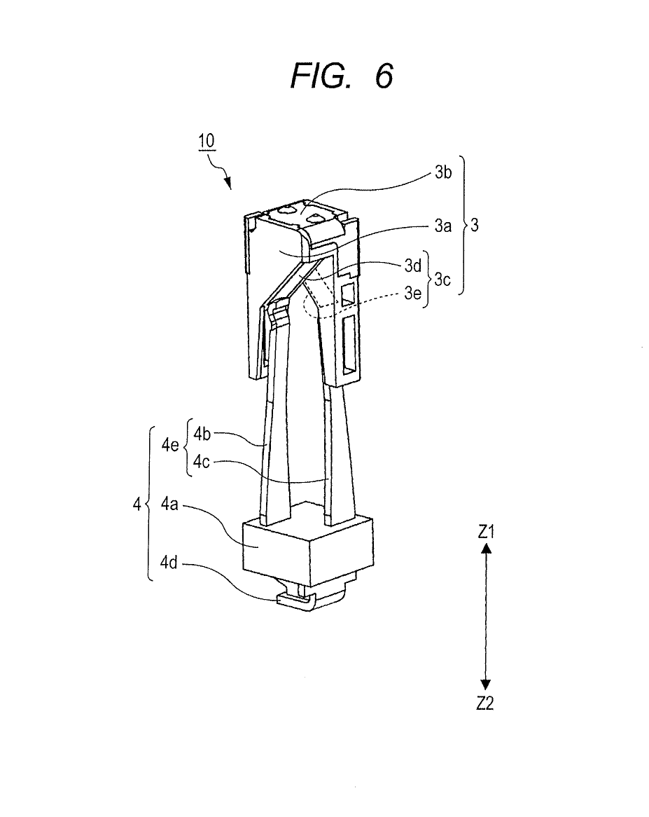

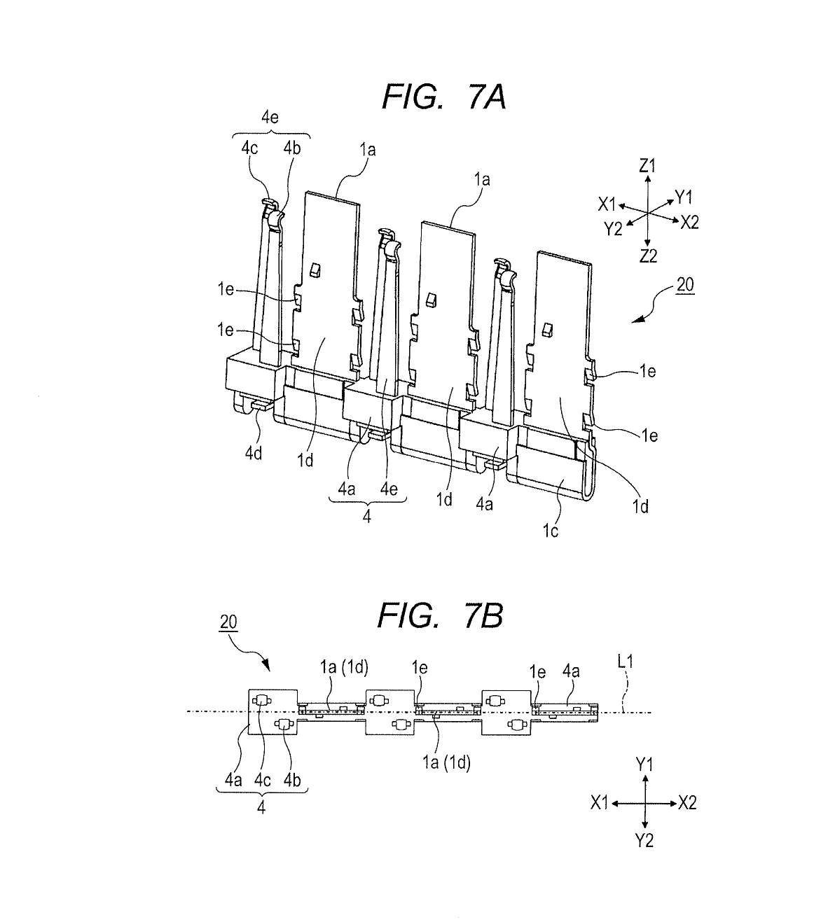

A socket 100 for electronic components according to a first embodiment will be described below. First of all, the structure of the socket 100 for electronic components according to this embodiment will be described with reference to FIGS. 1 to 7. FIGS. 1A and 1B are views showing the socket 100 for electronic components, FIG. 1A is a perspective view showing the appearance of the socket 100 for electronic components, and FIG. 1B is an enlarged view of a portion A shown in FIG. 1A. FIG. 2 is a plan view of the socket 100 for electronic components that is seen from a Z1 direction of FIG. 1A. Meanwhile, only a part of moving members 3 are shown in FIGS. 1A, 1B and 2 for the purpose of easy illustration. FIGS. 3A and 3B are views showing a case 2, FIG. 3A is a perspective view showing the appearance of the case 2, and FIG. 3B is a plan view of the case 2 that is seen from above. FIGS. 4A and 4B are views showing a first shield plate 1a, FIG. 4A is a perspective view of the first shield plate 1a, and FIG. 4B is a plan view of the first shield plate 1a that is seen from an X2 direction shown in FIG. 4A. FIG. 5 is a perspective view showing the appearance of a second shield plate 1b. FIG. 6 is a perspective view showing the structure of a contact unit 10. Meanwhile, FIG. 6 shows only one contact unit 10 for the purpose of easy illustration. FIGS. 7A and 7B are views showing a contact bar 20, FIG. 7A is a perspective view of the contact bar 20, and FIG. 7B is a plan view of the contact bar 20 that is seen from the Z1 direction shown in FIG. 7A.

As shown in FIGS. 1A and 1B, the socket for electronic components includes a shield plate assembly 1 where a plurality of first shield plates 1a and a plurality of second shield plates 1b are combined with each other in the form of a lattice, contact units 10 that can be electrically connected to electrode terminals of electronic components, and a case 2 that holds the shield plate assembly 1 and the contact units 10. Further, each of the contact units 10 includes a moving member 3 that comes into contact with and can be electrically connected to an electrode terminal of an electronic component and an elastic member 4 that has conductivity and elasticity.

As shown in FIG. 3, the case 2 is made of a synthetic resin material and is formed in a rectangular parallelepiped shape. The case 2 includes a receiving portion 2a that can receive and hold the shield plate assembly 1 and the contact units 10. The receiving portion 2a is formed in the shape of a recess that is opened at the upper portion of the case 2 in a quadrilateral shape.

As shown in FIGS. 1A, 1B, and 2, the shield plate assembly 1 is formed by combining the plurality of first and second shield plates 1a and 1b, which are formed of metal plates, in the form of a lattice. The shield plate assembly 1 is formed in a shape where a plurality of lines where quadrilateral openings 1h of a lattice are lined up in a first direction that is a Y1-Y2 direction are arranged side by side in a second direction that is an X1-X2 direction orthogonal to the first direction. Further, the openings 1h of the adjacent lines are formed so as to be shifted relative to the openings 1h of the next lines in the first direction by a half of the length of the side of the opening 1h that extends in the first direction.

The first shield plate 1a is formed by bending a metal plate as shown in FIGS. 4A and 4B. An insertion portion 1c, which is inserted into a part of the receiving portion 2a of the case 2, is formed at one end of the first shield plate 1a by being bent so as to be folded. The first shield plate 1a includes a first wall portion 1d, which is formed in the shape of a flat plate and forms a part of the lattice of the shield plate assembly 1, at the other end thereof. Furthermore, the first shield plate 1a includes spring portions 1e, which are formed in the form of a leaf spring and can come into press contact with the second shield plate 1b, at both end portions of the first wall portion 1d in a width direction (an X1-X2 direction).

The second shield plate 1b is formed of a metal plate in the shape of a flat plate as shown in FIG. 5. The second shield plate 1b includes a second wall portion 1f that is formed in the shape of a flat plate and forms a part of the lattice of the shield plate assembly 1. A plurality of engaging portions 1g, which are formed in the shape of a cut, are formed at regular intervals at an end portion B of the second wall portion 1f that is disposed on the bottom in the receiving portion 2a when the shield plate assembly 1 is formed. Further, the width of the engaging portion 1g near the end portion B is larger than the width of the engaging portion 1g at the position that is separated from the end portion B by a predetermined distance. Furthermore, the length of the second shield plate 1b is set to be longer than the width of a portion of the receiving portion 2a of the case 2 where the second shield plate 1b is disposed, and is set to a length that the second shield plate 1b can be press-fitted when being disposed.

As shown in FIG. 6, the contact unit 10 includes the moving member 3 and the elastic member 4. The moving member 3 is formed of a synthetic resin material and a metal plate in a substantially rectangular parallelepiped shape, and can come into contact with and be electrically connected to an electrode terminal of an electronic component. The moving member 3 includes a pedestal portion 3a that is made of a synthetic resin material and is formed in a rectangular parallelepiped shape, a contact 3b that is formed of a metal plate and can come into contact with an electrode terminal of an electronic component, and a conductive portion 3c that is electrically connected to the contact 3b. The contact 3b is formed on the upper surface (the surface corresponding to the Z1 direction) of the pedestal portion 3a, and the conductive portion 3c is formed on the lower surface (the surface corresponding to a Z2 direction) of the pedestal portion 3a. The conductive portion 3c includes a first inclined portion 3d that includes a surface inclined toward one side with respect to a moving direction (Z1-Z2 direction) of the moving member 3, and a second inclined portion 3e that includes a surface inclined toward the other side with respect to the moving direction (Z1-Z2 direction) of the moving member 3.

The elastic member 4 includes a base portion 4a that is made of a synthetic resin material and is formed in a rectangular parallelepiped shape; first and second elastic portions 4b and 4c that are formed of metal plates, have conductivity and elasticity, and are formed in the form of a leaf spring extending from the upper surface (the surface corresponding to the Z1 direction) of the base portion 4a in the moving direction (Z1-Z2 direction) of the moving member 3; and a contact portion 4d that is formed of a metal plate, is formed so as to protrude from the lower surface (the surface corresponding to the Z2 direction) of the base portion 4a, and can come into contact with the wiring of a wiring board (not shown). The first and second elastic portions 4b and 4c are electrically connected to the contact portion 4d.

The shield plate assembly 1 and the contact units 10 have been separately described as separate components. However, in this embodiment, the elastic members 4 and the first shield plates 1a are used in the form of a contact bar 20 that is a unit component where the elastic members 4 and the first shield plates 1a are integrated with each other as shown in FIGS. 7A and 7B. The contact bar 20 is formed by alternately arranging the elastic members 4 and the first shield plates 1a in a line at a predetermined interval. Meanwhile, the contact bar 20 is formed so that elastic portions 4e including the first and second elastic portions 4b and 4c and the first shield plates 1a protrude in the Z1 direction from the base portions 4a of the elastic members 4 extend in one direction (X1-X2 direction). Further, the contact portion 4d is formed at a position that is opposite to the elastic portion 4e with the base portion 4a interposed therebetween, and the insertion portion 1c of the first shield plate 1a is formed at a position that is opposite to the first wall portion 1d of the first shield plate 1a with the base portion 4a interposed therebetween. In the plan view of the base portion 4a that is seen from the Z1 direction, the width of a portion of the base portion 4a, on which the elastic portion 4e is disposed, in the Y1-Y2 direction is larger than the width of a portion where the first shield plate 1a is disposed.

A state where the elastic portions 4e and the first shield plates 1a of the contact bar 20 are disposed will be described below with reference to FIG. 7B. Meanwhile, an imaginary straight line L1 shown in FIG. 7B is a straight line that is parallel to the X1-X2 direction shown in FIG. 7A. As shown in FIG. 7B, the first shield plates 1a are disposed so that the first wall portions 1d serving as the inner walls of the lattice of the shield plate assembly 1 are parallel to the imaginary straight line L1. In this case, the first and second elastic portions 4b and 4c are disposed at different positions that are arranged along the imaginary straight line L1 with the imaginary straight line L1 interposed therebetween. Each of the first elastic portions 4b is disposed on one side, which corresponds to the Y2 direction, of the imaginary straight line L1 and on one side corresponding to the X2 direction along the imaginary straight line L1; and each of the second elastic portions 4c is disposed on the other side, which corresponds to the Y1 direction, of the imaginary straight line L1 and on the other side corresponding to the X1 direction along the imaginary straight line L1. Meanwhile, a distance between the first elastic portion 4b and the imaginary straight line L1 is the same as a distance between the second elastic portion 4c and the imaginary straight line L1.

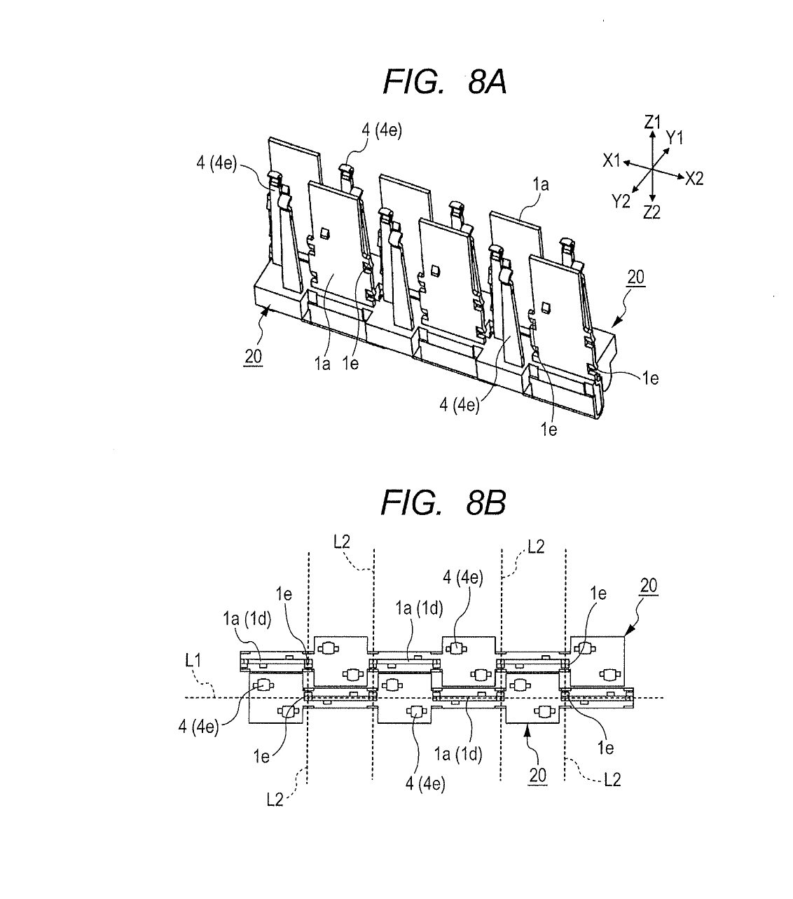

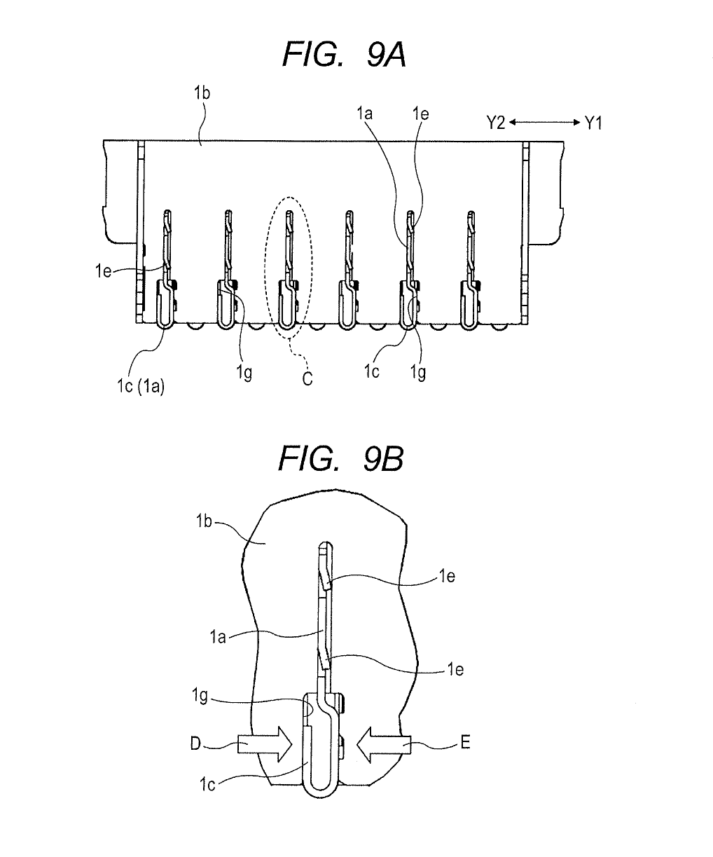

Next, the structure of the socket 100 for electronic components will be described with reference to FIGS. 2, 6, 8, and 9. FIGS. 8A and 8B are views showing a state where the contact bars 20 are disposed, FIG. 8A is a perspective view showing the state where the contact bars 20 are disposed, and FIG. 8B is a plan view showing the state where the contact bars 20 are disposed that is seen from the Z1 direction of FIG. 8A. Meanwhile, FIGS. 8A and 8B show only a pair of contact bars 20 for the purpose of easy illustration. FIGS. 9A and 9B are views showing a state where the spring portions 1e are engaged with the engaging portions 1g, FIG. 9A is a side view showing the state where the spring portions 1e are engaged with the engaging portions 1g, and FIG. 9B is an enlarged view of a portion C shown in FIG. 9A. Meanwhile, the case 2 is not shown in FIGS. 9A and 9B for the purpose of easy illustration.

As shown in FIG. 2, the elastic members 4 and the first shield plates 1a are disposed in the receiving portion 2a of the case 2 in the form of the contact bar 20. In this case, the plurality of contact bars 20 are arranged side by side in the Y1-Y2 direction, which is the first direction, at regular intervals so that the longitudinal directions of the contact bars are parallel to the X1-X2 direction that is the second direction. Further, the regular interval is a half of the length PT of the side of the opening 1h that extends in the first direction, and the contact bars 20 are disposed side by side from the first line to the (n)th line (n is 2 or more) so as to form a plurality of lines in the Y1-Y2 direction that is the first direction orthogonal to the X1-X2 direction. In this case, as shown in FIG. 8B, a pair of contact bars 20, which are disposed on the (n−1)th line and the (n)th line and are adjacent to each other, are arranged side by side so that the contact bars 20 are shifted relative to each other in the X1-X2 direction by a predetermined interval that is an interval between the disposed elastic portions 4e and an interval between the disposed first shield plates 1a and the first shield plates 1a of one contact bar 20 are adjacent to the elastic members 4 of the other contact bar 20. Furthermore, the contact bars 20 are disposed so that the spring portions 1e of the first shield plates 1a are arranged side by side on imaginary straight lines L2 orthogonal to the imaginary straight line L1.

As shown in FIG. 2, the second shield plates 1b are disposed along the imaginary straight lines L2 in the receiving portion 2a so as to be orthogonal to the first shield plates 1a. Accordingly, the plurality of second shield plates 1b are disposed so that both ends of the first shield plates 1a in the X1-X2 direction, which is the second direction, are interposed between the second shield plates 1b. As a result, the lattice of the shield plate assembly 1 is formed. The lattice of the shield plate assembly 1 forms lines in the Y1-Y2 direction that is the first direction and is formed from the first line to the (p)th line (p is 2 or more). Further, the lattice of the adjacent lines is formed so as to be shifted relative to the lattice of the next lines in the first direction by a half of the length PT of the side of the opening 1h that extends in the direction of the line.

Moreover, when the second shield plates 1b are held in the receiving portion 2a of the case 2, the second shield plates 1b are held so that a part of the first shield plate 1a are inserted into the engaging portions 1g of the second shield plate 1b as shown in FIG. 9A. Further, when the second shield plates 1b are disposed in the receiving portion 2a, the length of the second shield plate 1b is set to be longer than the width of a portion of the receiving portion 2a of the case 2 where the second shield plate 1b is disposed, and is set to a length that the second shield plate 1b can be press-fitted when being disposed. Accordingly, the second shield plates 1b are pressed in the Y1 direction and the Y2 direction. In this case, the engaging portion 1g is bent in the directions of arrows D and E shown in FIG. 9B, is abutted against the spring portions 1e and the insertion portion 1c, and comes into press contact with the spring portions 1e and the insertion portion 1c while bending the spring portions 1e and the insertion portion 1c. Accordingly, the first and second shield plates 1a and 1b are electrically connected to each other.

The moving members 3 are disposed in the openings 1h of the shield plate assembly 1 formed by the first and second shield plates 1a and 1b so that the conductive portion 3c is oriented in the direction where the conductive portion 3c comes into contact with the first and second elastic portions 4b and 4c as shown in FIG. 6. Accordingly, the contact units 10 are formed in the lattice of the shield plate assembly 1. The moving member 3 is disposed at the end portion of the elastic portion 4e of the elastic member 4 so as to be electrically connected to the elastic member 4. Therefore, as the moving member 3 comes into contact with an electrode terminal of an electronic component, the moving member 3 can be moved against the elasticity of the elastic portion 4e of the elastic member 4 in the direction where the moving member 3 is pressed. The socket 100 for electronic components is formed in this way.

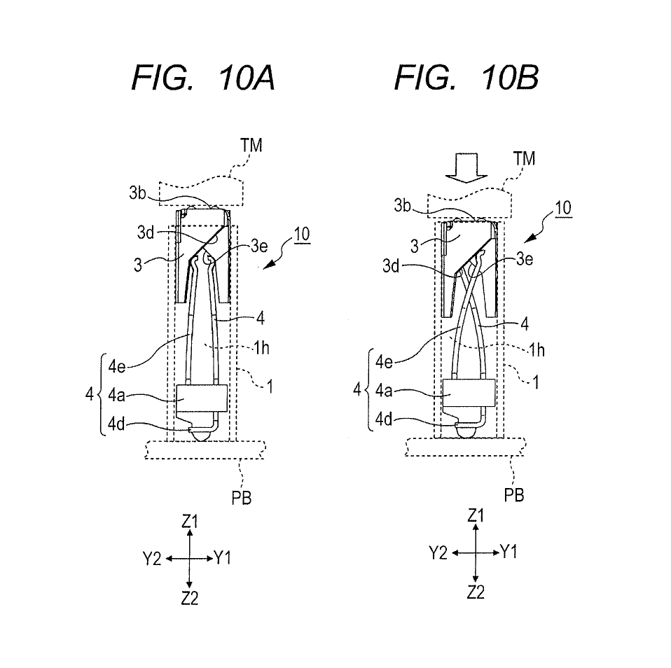

Next, the operation of the socket 100 for electronic components will be described with reference to FIG. 10. FIGS. 10A and 10B are side views illustrating the operation of the socket 100 for electronic components, FIG. 10A is a side view showing the socket 100 for electronic components that is in an initial state, and FIG. 10B is a side view showing the socket 100 for electronic components that has operated. Meanwhile, FIGS. 10A and 10B shows the operation of only the contact unit 10 that is provided in an arbitrary opening 1h for the purpose of easy illustration.

The socket 100 for electronic components is used to electrically connect electronic components to a wiring board. The socket 100 for electronic components is used while being electrically connected to and held on a wiring board PB by soldering or the like. When electronic components (not shown) are inserted into the socket 100 for electronic components from the Z1 direction shown in FIG. 1A, electrode terminals TM of the electronic components come into contact with the contacts 3b of the moving members 3. After that, with the insertion of the electronic components, the moving members 3 are moved against the elastic forces of the elastic portions 4e of the elastic members 4 in an insertion direction of the electronic component (Z2 direction). When the moving member 3 is pressed against the elastic force of the elastic portion 4e of the elastic member 4, the elastic portion 4e is bent and comes into press contact with the first and second inclined portions 3d and 3e. Accordingly, the electrical connection between the electrode terminal of the electronic component and the contact 3b of the moving member 3 becomes stable and the electrical connection between the conductive portion 3c of the moving member 3 and the elastic portion 4e of the elastic member 4 becomes stable. Therefore, it is possible to electrically connect electronic components to a wiring board by the socket 100 for electronic components.

An effect of this embodiment will be described below.

The socket 100 for electronic components according to this embodiment is adapted as follows: the socket 100 includes the shield plate assembly 1 that is formed by combining the plurality of first shield plates 1a with the plurality of second shield plates 1b in the form of a lattice and has conductivity; the contact units 10, which can be electrically connected to electrode terminals of electronic components, are disposed in the openings 1h of the lattice of the shield plate assembly 1 so that the electrode terminals of the electronic components can be electrically connected to the wiring of a wiring board; the shield plate assembly 1 is formed in a shape where a plurality of lines where the quadrilateral openings 1h of the lattice are lined up in the first direction that is the Y1-Y2 direction are arranged side by side in the second direction that is the X1-X2 direction orthogonal to the first direction; and the openings 1h of the adjacent lines are formed so as to be shifted relative to the openings 1h of the next lines in the first direction by a half of the length of the side of the opening 1h that extends in the first direction.

Accordingly, the openings 1h of the lattice of the adjacent lines of the lines of the lattice of the shield plate assembly 1 are formed so as to be shifted relative to the openings 1h of the lattice of the next lines in the first direction by a half of the length PT of the side of the opening 1h that extends in the first direction. For this reason, since the electronic component and the moving member are electrically connected to each other near the position of the center of gravity of the opening 1h in the plan view of the opening 1h, it is possible to obtain an effect of coping with the electrical connection to electronic components where electrode terminals are arranged at the positions of intersections of a rhombic lattice.

Further, if the shape of the lattice of the shield plate assembly 1 is a rhombic shape as in the related art disclosed in U.S. Pat. No. 6,877,223, various kinds of shield plates having different lengths are needed. In contrast, since the kinds of the shield plates of the shield plate assembly 1 are reduced (two kinds of shield plates), the structure of the socket becomes simple. Accordingly, it is possible to obtain an effect of providing a socket for electronic components that can be manufactured at a low cost.

Furthermore, the socket 100 for electronic components according to this embodiment is adapted as follows: each of the contact units 10 includes the moving member 3 that comes into contact with and can be electrically connected to an electrode terminal of an electronic component and the elastic member 4 that has conductivity and elasticity; the contact bars 20 are formed by alternately arranging the elastic members 4 and the first shield plates 1a in a line at a predetermined interval; the plurality of contact bars 20 are arranged side by side in the first direction at regular intervals so that the longitudinal directions of the contact bars are parallel to the second direction; the regular interval is set to a half of the length PT of the side of the opening 1h that extends in the first direction; the plurality of second shield plates 1b are disposed so that both ends of the first shield plates 1a in the second direction are interposed between the second shield plates 1b, thereby forming the lattice of the shield plate assembly; and the moving members 3 are disposed in the openings 1h of the shield plate assembly 1, so that the contact units 10 are formed in the lattice.

Accordingly, since the contact bar 20, which is obtained by forming the plurality of elastic members 4 and the plurality of first shield plates 1a in the form of a unit, is used, the structure of the socket becomes simpler and the socket is easily assembled. As a result, it is possible to obtain an effect of providing a socket for electronic components that can be manufactured at a lower cost.

Moreover, the socket 100 for electronic components according to this embodiment is adapted as follows: the contact bar 20 includes the elastic members 4 and the base portions 4a holding the first shield plates 1a; and the elastic members 4 and the first shield plates 1a are formed so as to protrude from the base portions 4a in the same direction.

Accordingly, since the contact bar 20 (the contact units 10) is formed using the elastic portions 4e having elasticity, electrical connection is made while biasing electronic components. Therefore, it is possible to obtain a more stable electrical connection. Further, since the contact bar 20 (the contact units 10) is formed using the elastic portions 4e having elasticity, it is possible to absorb an impact generated when the electronic component comes into contact with the contact bar 20 (the contact unit 10). Accordingly, it is possible to obtain an effect of preventing the breakage of an electrode of an electronic component and the contact bar 20 (the contact unit 10).

Furthermore, the socket 100 for electronic components according to this embodiment is adapted as follows: the moving member 3 is disposed at the end portion of the elastic member 4 so as to be electrically connected to the elastic member 4, and is moved against the elasticity of the elastic member 4 when being pressed by coming into contact with an electrode terminal of an electronic component.

Accordingly, since the moving member 3 is disposed at the end portion of the elastic member 4 so as to be electrically connected to the elastic member 4 and is adapted to be moved against the elasticity of the elastic member 4 when being pressed, the moving member 3 and the elastic member 4 come into press contact with each other. Therefore, it is possible to obtain an effect of further stabilizing the electrical connection between the moving member 3 and the elastic member 4.

### Second Embodiment

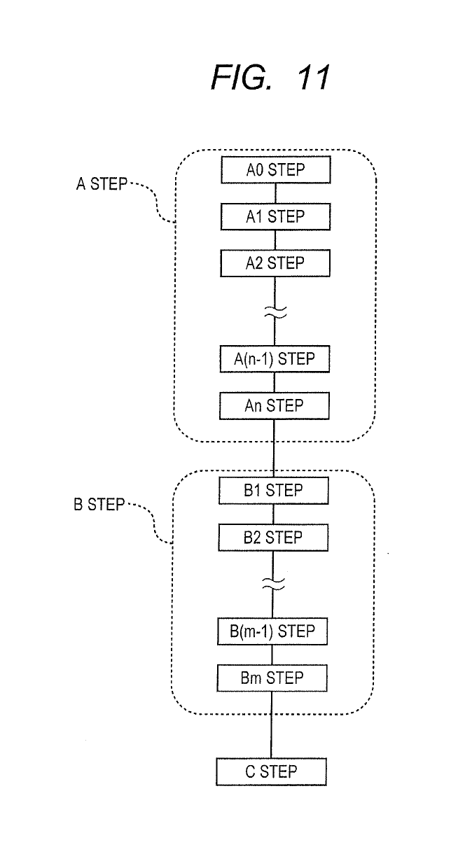

method of manufacturing the socket 100 for electronic components, which has been described as the first embodiment, will be described with reference to FIGS. 2, 9, and 11. FIG. 11 is a view illustrating a flow of steps of the method of manufacturing the socket 100 for electronic components.

As shown in FIG. 11, the assembly of the socket 100 for electronic components includes A step, B step, and C step. B step is performed after A step, and C step is then performed. Meanwhile, A step includes A0 step and A1 to An steps (n is 2 or more). A0 to An steps are sequentially performed in this order. Further, B step includes B1 to Bm steps (m is 2 or more), and B1 to Bm steps are sequentially performed in this order.

A step is a step of forming the contact bars 20 and disposing the contact bars 20 in the receiving portion 2a of the case 2 in a second direction such as the X1-X2 direction shown in FIG. 2. A0 step is a step of forming a predetermined number of contact bars 20 where the elastic members 4 and the first shield plates 1a are alternately arranged in a line at a predetermined interval. Meanwhile, the socket 100 for electronic components shown in FIG. 2 requires twelve contact bars 20.

A1 step is a step of disposing a first contact bar 201 among the contact bars 20 so that the longitudinal direction of the first contact bar 201 is parallel to the second direction. For example, as shown in FIG. 2, the first contact bar 201 is disposed along the inner surface of the receiving portion 2a corresponding to the Y2 direction.

A2 step is a step of disposing a second contact bar 202 among the contact bars 20 so that the longitudinal direction of the second contact bar 202 is parallel to the second direction and the second contact bar 202 is separated from the first contact bar 201 by a half of the length PT of the side of the opening 1h extending in the first direction and is shifted relative to the first contact bar 201 toward one side in the second direction by the predetermined interval. In the socket 100 for electronic components shown in FIG. 2, the second contact bar 202 is separated from the first contact bar 201 in the Y1 direction and is disposed so as to be shifted relative to the first contact bar 201 toward one side in the second direction corresponding to the X2 direction by a predetermined interval.

A3 step is a step of disposing a third contact bar 203 among the contact bars 20 so that the longitudinal direction of the third contact bar 203 is parallel to the second direction and the third contact bar 203 is separated from the second contact bar 202 toward the side where the first contact bar 201 is not disposed by a half of the length PT of the side of the opening 1h extending in the first direction and is shifted relative to the second contact bar 202 toward the other side in the second direction by the predetermined interval.

The same steps as A1 to A3 steps are repeated predetermined n times (n is 2 or more), and An step is performed to dispose the (n)th contact bar 20n in the receiving portion 2a. Meanwhile, as for the socket 100 for electronic components shown in FIG. 2, steps are performed up to A12 step to dispose the twelfth contact bar 2012.

B step is a step of loading the plurality of second shield plates 1b onto the first to (n)th contact bars 201 to 20n disposed in the receiving portion 2a of the case 2 by A1 to An steps so that both ends of the first shield plates 1a in the first direction are interposed between the second shield plates 1b. B1 step is a step of disposing one second shield plate 1b in the first direction so that the second shield plate 1b comes into contact with any one end portion of any one first shield plate 1a in the first direction. In this case, the second shield plate 1b is held so that a part of the first shield plate 1a is inserted into the engaging portion 1g of the second shield plate 1b as shown in FIG. 9A. B2 step is a step of disposing one second shield plate 1b in the same manner as the B1 step at a position that is different from the position of B1 step. The same steps as B1 and B2 steps are performed up to Bm step in which the loading of a predetermined number of second shield plates 1b (m second shield plates 1b, m is 2 or more) is completed. When B step is completed, the second shield plates 1b are disposed so that both ends of the first shield plates 1a in the first direction are interposed between the second shield plates 1b. As a result, the shield plate assembly 1 is formed. Meanwhile, after, for example, a second shield plate 1b may be loaded in B1 step at a position where the second shield plate 1b can be loaded along the inner surface of the receiving portion 2a corresponding to the X1 direction, second shield plates 1b may be sequentially loaded in the X2 direction in the respective steps of B step at the positions where the second shield plates 1b can be loaded.

C step is a step of fitting the moving members 3 into the openings 1h of the lattice-like shield plate assembly 1 that is formed by A1 to An steps and B1 to Bm steps.

The assembly of the socket 100 for electronic components is performed by sequentially performing A step, B step, and C step.

An effect of this embodiment will be described below.

The method of manufacturing the socket 100 for electronic components according to this embodiment includes a step of sequentially performing A step of disposing the contact bars 20 in the receiving portion 2a of the case 2, B step of loading the second shield plates 1b, and C step of fitting the moving members 3 into the openings 1h.

Accordingly, since the elastic members 4 and the first shield plates 1a are formed in the form of a unit as the contact bars 20, it is possible to reduce the number of parts and to make an assembling step easy as compared to a case where the elastic members 4 and the first shield plates 1a are separately formed and are assembled. Therefore, productivity is improved, so that it is possible to obtain an effect of reducing production costs.

Further, since the contact bar 20 of this embodiment is formed by alternately arranging three elastic members 4 and three first shield plates 1a side by side, it is possible to dispose the contact bars so that the contact bars are shifted relative to each other toward one side in the second direction by a predetermined interval, by disposing the contact bars in parallel so that the orientation of the (n)th contact bar 20n is opposite to the orientation of the (n−1)th contact bar 20(n−1). As a result, it is possible to make an assembling step easy. Accordingly, productivity is improved, so that it is possible to obtain an effect of reducing production costs.

The socket 100 for electronic components and the method of manufacturing the socket 100 according to the embodiments of the invention have been specifically described above, but the invention is not limited to the above-mentioned embodiments and may be modified in various ways without departing from the scope of the invention. For example, the invention may have the following embodiments and these embodiments are also included in the scope of the invention.

(1) In the first embodiment, the contact unit 10 has included the moving member 3 and the elastic member 4. However, the moving member 3 and the elastic member 4 may be integrated with each other, and the elastic portion 4e of the elastic member 4 may not be formed in the form of a leaf spring and may be formed of other biasing members.

(2) In the first embodiment, the contact bar 20 has been formed by arranging three sets of the combination of the elastic member 4 and the first shield plate 1a side by side. However, the contact bar 20 may be appropriately modified according to the size or the like of the socket 100 for electronic components.

(3) In the second embodiment, the second shield plates 1b have been sequentially disposed in the respective steps of B step from any one side in the first direction at the positions where the second shield plates 1b can be disposed. However, the second shield plates 1b may be disposed from any position as long as there is no trouble in the assembly.

It should be understood by those skilled in the art that various modifications, combinations, sub-combinations and alterations may occur depending on design requirements and other factors insofar as they are within the scope of the appended claims of the equivalents thereof.

What is claimed is:

1. A socket for electronic components including;
a shield plate assembly comprising a plurality of first shield plates and a plurality of second shield plates in the form of a lattice and having conductivity, and contact units, which are electrically connected to electrode terminals of electronic components, being disposed in openings of the lattice of the shield plate assembly so that the electrode terminals of the electronic components are electrically connected to the wiring of a wiring board,
wherein the shield plate assembly has a shape where a plurality of lines where quadrilateral openings of the lattice are lined up in a first direction are arranged side by side in a second direction orthogonal to the first direction, and the openings of the adjacent lines are arranged so as to be shifted relative to the openings of the next lines in the first direction by a half of the length of the side of the opening that extends in the first direction.

2. The socket for electronic components according to claim 1,
wherein the contact unit includes a moving member that comes into contact with and is electrically connected to the electrode terminal of the electronic component and an elastic member that has conductivity and elasticity,
contact bars are formed by alternately arranging the elastic members and the first shield plates in a line at a predetermined interval,
the plurality of contact bars are arranged side by side in the first direction at regular intervals so that longitudinal directions of the contact bars are parallel to the second direction,
the regular interval is set to a half of the length of the side of the opening that extends in the first direction,
the plurality of second shield plates are disposed so that both ends of the first shield plates in the second direction are interposed between the second shield plates, thereby forming the lattice of the shield plate assembly, and
the moving members are disposed in the openings of the shield plate assembly, so that the contact units are formed in the lattice.

3. The socket for electronic components according to claim 2,
wherein the contact bar includes the elastic members and base portions holding the first shield plates, and
the elastic members and the first shield plates are arranged so as to protrude from the base portions in the same direction.

4. The socket for electronic components according to claim 2,
wherein the moving member is disposed at an end portion of the elastic member so as to be electrically connected to the elastic member, and is moved against the elasticity of the elastic member when being pressed by coming into contact with the electrode terminal of the electronic component.

5. A method of manufacturing a socket for electronic components, the socket for electronic components including a shield plate assembly where a plurality of first shield plates and a plurality of second shield plates are combined with each other in the form of a lattice, contact units, which are electrically connected to electrode terminals of electronic components, being disposed in openings of the lattice of the shield plate assembly so that the electrode terminals of the electronic components are electrically connected to the wiring of a wiring board, the shield plate assembly being formed in a shape where a plurality of lines where quadrilateral openings of the lattice are lined up in a first direction are arranged side by side in a second direction orthogonal to the first direction, and the openings of the adjacent lines being formed so as to be shifted relative to the openings of the next lines in the first direction by a half of the length of the side of the opening that extends in the first direction, the method comprising:
A0) forming a predetermined number of contact bars where elastic members and the first shield plates are alternately arranged in a line at a predetermined interval;
A1) disposing a first contact bar among the contact bars so that the longitudinal direction of the first contact bar is parallel to the second direction;
A2) disposing a second contact bar among the contact bars so that the longitudinal direction of the second contact bar is parallel to the second direction and the second contact bar is separated from the first contact bar by a half of the length of the side of the opening extending in the first direction and is shifted relative to the first contact bar toward one side in the second direction by the predetermined interval;
A3) disposing a third contact bar among the contact bars so that the longitudinal direction of the third contact bar is parallel to the second direction and the third contact bar is separated from the second contact bar toward a side where the first contact bar is not disposed by a half of the length of the side of the opening extending in the first direction and is shifted relative to the second contact bar toward the other side in the second direction by the predetermined interval;
disposing a (n)th contact bar by repeating the same steps as A1 to A3 predetermined n times (n is 2 or more);
B1 to Bm) sequentially loading a predetermined number of the second shield plates (m second shield plates, m is 2 or more) onto the first to (n)th contact bars disposed by the A1 to An steps so that both ends of the first shield plates in the second direction are interposed between the second shield plates; and
C) fitting the moving members into the openings of the lattice-like shield plate assembly that is formed by A1 to An and B1 to Bm.
